(19) United States
(12) Patent Application Publication
(10) Pub. No.: US 2010/0169207 A1
(43) Pub. Date: Jul. 1, 2010

(54) Sovereign certificates issuance plan

(76) Inventor: Galvin Flowers, JR., Franklin, TN (US)

Correspondence Address: Galvin Flowers, Jr, 207 Old Liberty Pike, Franklin, TN, 37064, US

(21) Appl. No.: 12/655,156

(22) Filed: Dec. 23, 2009

Related U.S. Application Data
(60) Provisional application No. 61/203,645, filed on Dec. 29, 2008.

(51) Int. Cl. G06Q 40/00

(52) U.S. Cl. 705/37

(57) ABSTRACT

This business method will enable me and my company to provide limited financing to the Federal government so that it can pay for certain expenditures without incurring debt. It consists of an actual business method which creates a public-private relationship to facilitate the funding process, as well as a new type of investment security that is sold into the capital markets to raise the needed funds. The security is a non-debt instrument whose sole purpose is capital appreciation. It is comprised of components to specifically raise and allocate the needed funds, and to control the sale and appreciation rates. The security must be sanctioned and backed by the full faith and credit of the Federal government. The securities will be sold and traded exclusively on a computerized exchange platform owned and operated by my business.

This non-provisional patent application references a previously filed provisional patent application that I filed with the USPTO on Dec. 29, 2008. Its title was also The Sovereign Certificates Issuance Plan. The application No. is 61/203,645. I was granted a foreign filing license on Jan. 28, 2009. The country code and number of my priority application is U.S. 61/203,645.

The Sovereign Certificates Issuance Plan is a business method which I, Galvin Flowers, Jr., a resident of 207 Old Liberty Pike in Franklin, Tenn. 37064, and citizen of the United States of America, claim to be the original and sole inventor of.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

My invention, The Sovereign Certificates Issuance Plan, is a business method which pertains to the fields of Economics and finance.

Throughout the history of the United States of America, the Federal government has paid its debts and provided for the general welfare and common defense of its citizenry by a variety of means, including taxes, duties, imposts, excises, and the sale of fixed income debt securities in the capital markets.

During times of economic prosperity, when government coffers are flush with revenue, it is relatively easy for the Federal government to repay its debts and fund its basic operations and numerous programs. But during economic downturns, this becomes exceedingly more difficult to do.

These facts can be attested to by simply referencing general History and Economics textbooks. It can also be substantiated by numerous government publications from such entities as the Internal Revenue Service and the Congressional Budget Office, just to name a few.

With the United States of America currently facing a multitude of financial and economic problems, it is imperative that we develop alternative forms of financing to supplement our government's existing revenue structure. The Sovereign Certificates Issuance Plan can provide such assistance.

### BRIEF SUMMARY OF THE INVENTION

Based upon extensive research and analysis, I have come to the conclusion that aspects of our Federal government's revenue acquisition systems are rapidly becoming inadequate to effectively deal with a wide range of financial problems our government is presently facing, and will face in the future.

This assessment is based on a variety of factors, including, but not limited to, decreases in corporate tax revenue due to increased international competition, as well as massive Federal and National debts resulting from an apparent unwillingness by the American people and their elected officials to control ever increasing government expenditures.

It is because of this that I have invented this business method, The Sovereign Certificates Issuance Plan, to provide the Federal government with a private sector business instrument to assist in meeting some of its monetary needs.

This business method I have invented will allow my business and I to provide the Federal government with limited amounts of money to fund some of its most pressing needs, all without incurring debt and having to repay the money at a future date.

This invention can also be utilized to give monetary assistance to non-Federal governmental entities, and to private sector enterprises, primarily financially distressed corporations whose demise could cause serious consequences to the American economy.

This process is accomplished by my company, working in a public-private relationship with the Federal government, issuing for sale in the capital markets a unique new investment security I have invented called a Sovereign Certificate.

These investment securities are instruments of capital appreciation, not debt securities. Therefore, when sold in its initial public offering, the security provides the Federal government with money that does not have to be repaid at any point in the future, and on which no dividends or interest is paid. For its part, investors purchasing Sovereign Certificates will receive a security backed by the full faith and credit of the United States government and whose sole purpose is capital appreciation at a level not found in government debt securities.

I would like to conclude this summary by stating that I created this business method for the purpose of supplemental funding. If the government wishes to increase its tax revenues to fund its programs and operations, the traditional method of proper taxation combined with sound fiscal and economic policies have proven themselves irreplaceable as the best engines for economic growth. Still, The Sovereign Certificates Issuance Plan is a major innovation in the area of sovereign finance.

### BRIEF DESCRIPTION OF THE SEVERAL VIEWS OF THE DRAWING

Not Applicable

### DETAILED DESCRIPTION OF THE INVENTION

As stated in the Brief Summary of the Invention, the purpose of this invention is to provide me and my business with a business method that can be utilized to give limited monetary assistance to the Federal government, all in such a way that no debt is incurred by the government.

There are two main components of this invention that allow this to be accomplished. First, there is the actual business method which allows me and my business to work in a public-private relationship with the Federal government to provide the funding to it. Second, there are the new investment securities that work in conjunction with the actual business method.

As for the exact legal structure of the public-private relationship, this is a matter to be negotiated between me and the government. But the Federal government will have complete supervisory powers over my business and this process, allowing it to be the sole authority to authorize the sale of Sovereign Certificates. Under no circumstances can these securities be sold into the capital markets without explicit government authorization.

There are two ways in which my business and I will provide the money to the Federal government. The first is by direct transfer. This means that after the Certificates are sold in the initial public offering, the money raised will be directly transfered to the government. The second is through an underwriting process. With this option, my business and I will borrow the money needed by the government and transfer it to the government. Afterwards, my business and I will sell the Certificates in the initial public offering and retain the proceeds of the sale to repay the loans.

The choice of which of these two options to use will be at the sole discretion of the Federal government.

During the initial public offering for the Certificates pertaining to the process labeled direct transfer, any Certificates that are not sold will be purchased by me and my business. This will allow the Federal government to receive the full funding it has contracted for. The Federal government is under no circumstances liable for any such debts incurred by me and my business.

If the underwriting option is used, any Certificates not sold during the initial public offering will be held on my company's books until they can be sold. Again, the Federal government cannot be held liable for any debts incurred by me and my business.

A Sovereign Certificate is composed of two parts: Type and Class. There are three Types of Sovereign Certificates; Sovereign, Sovereign-Private, and Private. These are more thoroughly explained later in the description.

There are two Classes of Sovereign Certificates. They are Active Class and Fixed Class.

Active Class: This Class of Certificate is so named because its price is based upon daily trading.

Fixed Class: This Certificate is sold with a fixed Trading Rate. This dictates the number of times the security can be sold in a twelve month period. This particular Class is also issued with a fixed Appreciation Rate, which sets the amount the security can be sold for. They can only be sold for the fixed Appreciation Rate. They cannot be sold for any amount above or below this rate.

Although the average well diversified investor will most likely find both Classes appealing, the Active Class will more likely appeal to aggresive investors, while the Fixed Class will appeal to the more risk averse conservative investor.

Two Types and both Classes of Sovereign Certificates are transformable. For the two Types labeled as Sovereign-Private and Private, this means that under the properly defined circumstances, they can be transformed totally into the Type labeled Sovereign. This is more thoroughly explained later in this description.

For the two Classes, this means that one can be totally transformed into another. This is accomplished for the Active Class by freezing the price and adding a fixed Trading Rate and Appreciation Rate. For the Fixed Class, it is transformed into an Active Class security by eliminating the Trading Rate and Appreciation Rate and allowing the price to be set by market trading.

Also, Certificates can be issued with a combination of both Classes. This is done by issuing the security with one Class, along with the stipulation that it will totally transform into the other Class at a certain date in the future.

The Fixed Class can have its Trading Rate and Appreciation Rate reset at any time by my intervention in the marketplace.

My business and I have the authority to intervene in the marketplace at any given time to transform one Class of Certificates into another, as well as reset the Trading Rate and Appreciation Rate of any Fixed Class Certificate.

I will notify the Federal government before such actions take place. If the Federal government believes the intervention inappropriate, it has the authority to overrule my decision and prevent the intervention.

The choice of which Class to use, as well as the appropriate Trading Rate and Appreciation Rate for any Fixed Class Certificate will be decided based upon consultations between me and my business and the Federal government.

The purpose for intervention is to control the flow of capital into both Classes. The primary purpose of our capital markets is to provide funding for corporations. If these Certificates are receiving an overflow of money and causing capital deficiencies in the corporate area, then transformations are necessary. An Active Class Certificate can be transformed into a Fixed Class Certificate to control overflow. An underflow of capital into these Certificates can be reversed by transforming a Fixed Class Certificate into an Active Class Certificate, or by adjusting upward the Appreciation Rate of a Fixed Class Certificate.

The securities that I have invented are subject to all existing Federal and State rules pertaining to the creation and issuance of securities. But because it is a new type of investment security that has been invented by me, many of these rules and regulations may not apply. This is also true in regards to Federal and State tax matters. These issues will have to be dealt with both before and after the Certificates are issued.

My business and I will work with advanced computer technology and software companies to create an in-house Exchange and fully electronic trading platform so that I can offer to the investing public the ability to purchase and trade all Types and Classes of Sovereign Certificates exclusively through my company.

If for whatever reason this is not feasible, my business and I will work with an existing Board of Exchange to create a trading platform for the exclusive purchasing and trading of all Types and Classes of Sovereign Certificates.

As stated previously in the Description of this invention, its primary purpose is to provide the Federal government with money that it does not have to repay. There are several other economic benefits provided by this business method. They are the following;

Safehaven Investments: Investors purchasing these securities will own an investment backed by the full faith and credit of the United States government. They will also be able to achieve a level of capital appreciation that has been virtually unseen in the area of government securities, such as Bills, Notes, and Bonds.

Revenue Enhancement: During times of economic weakness, most mainstream investments provide low returns, thus lowering tax revenues for the government. Because these Certificates are a safehaven investment, they will attract more investors. This will provide the Federal government with increased revenue due to increases in the price of the Active Class of Certificates. The Fixed Class of Certificates will provide revenue with its higher fixed rate of appreciation.

Alternative Investments: When traditional investments are providing low returns, there is often a flight by investors to riskier and higher yielding assets, such as commodities. When this occurs, the results are often negative, with higher commodity prices creating inflationary pressures and an artificial price bubble that eventually bursts. Sovereign Certificates offer investors an option, thus sparing our nation inflated value in this and other areas.

As stated previously in the description of this invention, there are three Types of Sovereign Certificates; Sovereign, Sovereign-Private, and Private.

The word Type means Category. I have divided the expenditures of the Federal government into three different Categories(Types). Each Type designates the particular Federal outlays that the money being raised by the issuance of the Sovereign Certificates will be used for.

When a Sovereign Certificate is issued for sale in its initial public offering, it will bear the Type in addition to the mandatory CUSIP registration number.

This will allow potential investors to know the reason for the issuance so that they can decide if an investment in the Certificates is appropriate for them.

Also, it can create diversity in the trading process. Just as the prices of stocks and bonds move opposite to one another, Certificates that differ by Type have the potential to trade opposite in price to each other.

The following section of this description consists of the definitions for the three Types of Sovereign Certificates, as well as detailed descriptions of the composition of Sovereign Certificates and the rules pertaining to their creation, issuance, and trading. The section concludes with three examples of how The Sovereign Certificates Issuance Plan can work.

Sovereign: When Sovereign Certificates are created and sold for the exclusive purpose of raising money to fund the traditional expenditures of the Federal government, this Type is labeled Sovereign.

For the purpose of this Type, I classify the following as traditional expenditures; Elimination of Federal Budgetary and National Debt, Social Security, Medicare, Retirement, National Defense, Veterans Programs, International Affairs, Social Programs, and Physical, Human, and Community Development. This list also includes Federal funding for certain non-Federal entities such as States, Municipalities, Affiliated Governmental Agencies, Government Sponsored Enterprises, Supranational Entities, and all others that do not fall under the Types labeled as Sovereign-Private and Private.

After the first initial public offering of these Types of Certificates, all subsequent issues will be consolidated into the original Types, creating an all encompassing set of Certificates. The manner in which this is accomplished and how the Certificates are priced will be detailed later in this section.

Although these Certificates are backed by the full faith and credit of the Federal government, an investment in them could result in a capital loss. Investors will be made aware of this risk before they are allowed to invest.

Ownership of these Certificates does not constitute ownership in my business. It also does not give the investor any special say in the issuance of the securities, or in any entity created to facilitate their sale or trade.

Regardless of which Class is used for the initial public offering of these Types of Certificates, the offering price is set and must be paid. No amount above or below the initial offering price is acceptable or allowed.

The Federal government can purchase and remove these Certificates from the market at its sole discretion.

When issued, this Type of Sovereign Certificate will bear its Type label in addition to its mandatory CUSIP number.

Sovereign-Private: When this Type of Sovereign Certificate is created and sold for the exclusive purpose of raising capital to give to the Federal government so that it in turn can give monetary assistance to financially distressed business entities, its Type is labeled Sovereign-Private.

In order for a financially troubled business to receive assistance, it must apply directly to the Federal government for such. If the Federal government deems it in the national economic interest to provide monetary assistance, it will then do so with my assistance. My business and I will play no part in the application process, or in the decision to grant or deny help to the distressed business. It is the sole responsibility of the Federal government to do so.

This particular Type of Certificate can only be issued for an individual company. It cannot be issued for a group of companies.

When a Sovereign Certificate is issued for an individual company, the name of the company will be listed along with its Type and CUSIP number.

If any business for which these Types of Certificates have been issued enters into bankruptcy and is dissolved, or is purchased by another company, or is nationalized by the Federal government, these Types of Certificates will automatically transform into the Type labeled Sovereign and be consolidated with that Type. All references to the name of the company will be removed. If there are no Certificates labeled Sovereign in existence at the time, the Certificates label of Sovereign-Private will still be removed and replaced with Sovereign, and they will trade as such.

This transformation will be automatically approved and guaranteed by the Federal government. It is done in an attempt to help preserve investor capital and confidence.

The business for which these Types have been issued can purchase them and remove them from market with government permission.

The Federal government has the right to condition its support for the creation and issuance of these Types of Certificates on the willingness of the business to purchase them and remove them from market at a future date, once its financial condition improves.

The Federal government can purchase and remove these Certificates from the market at its sole discretion.

If additional funding is necessary for the Federal government to give to the business, any new issues will be consolidated with existing Certificates already issued for the company.

Although these Certificates are backed by the full faith and credit of the Federal government, an investment in them could result in a capital loss. Investors will be made aware of this risk before they are allowed to invest.

Ownership of these Certificates does not constitute ownership in my business. It also does not give the investor any special say in the issuance of the securities, or in any entity created to facilitate their sale or trade.

Ownership of these Certificates does not constitute ownership in any business whose name appears on this Type of Sovereign Certificate.

Regardless of which Class is used for the initial public offering of these Types of Certificates, the offering price is set and must be paid. No amount above or below the initial offering price is acceptable or allowed.

Private: When this Type of Sovereign Certificate is created and sold for the exclusive purpose of raising capital to give to the Federal government so that it in turn can give monetary assistance to select financially stable businesses in hopes that it will spur further innovation and expansion in their respective fields of endeavor, the Type is labeled Private.

By providing this monetary assistance to a company, the Federal government will be helping to diminish somewhat the amount of debt the business normally undertakes to finance its operations. Additionally, it can help to minimize somewhat the dilutive effect on the company's stock price that issuing more stock to raise capital would have if the company chose this method to raise money.

In order for a financially stable business to receive assistance, it must apply directly to the Federal government for such. If the Federal government deems it in the national economic interest to provide monetary assistance, it will then do so with my assistance. My business and I will play no part in the application process, or in the decision to grant or deny assistance to the business. It is the sole responsibility of the Federal government to do this.

This particular Type of Certificate can only be issued for an individual company. It cannot be issued for a group of companies.

When a sovereign Certificate is issued for an individual company, the name of the company will be listed along with its Type and CUSIP number.

If any business for which this Type of Certificate has been issued enters into bankruptcy and is dissolved, or is purchased by another company, or is nationalized by the Federal government, these Types of Certificates automatically transform into the Type labeled Sovereign and will be consolidated with that Type. All references to the name of the company will be removed. If there are no Certificates labeled Sovereign in existence at the time, the Certificates' label of Private will still be removed and replaced with Sovereign, and they will trade as such.

This transformation will be automatically approved and guaranteed by the Federal government. It is done in an attempt to help preserve investor capital and confidence.

The business for which these Types have been issued can purchase them and remove them from market with government permission.

The Federal government has the right to condition its support for the creation and issuance of these Types of Certificates on the willingness of the business to purchase them and remove them from market at a future date.

The Federal government can purchase and remove these Certificates from the market at its sole discretion.

If additional funding is necessary for the Federal government to give to the business, any new issues will be consolidated with existing Certificates already issued for the company.

Although these Certificates are backed by the full faith and credit of the Federal government, an investment in them could result in a capital loss. Investors will be made aware of this risk before they are allowed to invest.

Ownership of these Certificates does not constitute ownership in my business. It also does not give the investor any special say in the issuance of the securities, or in any entity created to facilitate their sale or trade.

Ownership of these Certificates does not constitute ownership in any business whose name appears on this Type of Sovereign Certificate.

Regardless of which Class is used for the initial public offering of these Types of Certificates, the offering price is set and must be paid. No amount above or below the initial offering price is acceptable or allowed.

The term initial public offering is defined as when newly created Sovereign Certificates are issued for sale for the first time in the capital markets.

When one Class of Sovereign Certificates is transformed into another Class, they retain their CUSIP number. When Certificates bearing the Type label of Sovereign-Private or Private are transformed into the Type labeled Sovereign, they will have their CUSIP number removed and replaced with the CUSIP number of the Certificates they are being consolidated with.

The approved accounting procedure set forth by the Securities and Exchange Commission for the pricing of securities involves aggregating the securities, then dividing the sum by the shares outstanding. This procedure is applicable to the fullest extent for the Active Class of Certificates, but is only partially applicable for the Fixed Class of Certificates.

The Fixed Class of Sovereign Certificates is highly individualistic; their value at any given time is determined by the ability of the investor to sell the security, if they choose to sell at all. It is only when they are to be transformed into the Active Class that they are then aggregated, their sum divided by the number of Certificates, that a uniform price is established for them all to be issued with as an Active Class of Sovereign Certificates.

Example: The Federal government of the United States of America currently has a National Debt of $12.0 trillion US dollars. Because of the negative impact this is having on the nation, the government has decided to begin implementing steps to reduce the debt. I approach the government with an offer of assistance utilizing The Sovereign Certificates Issuance Plan. The government accepts my offer of assistance, and directs me to eliminate $1.0 trillion dollars of debt over a period of 24 months. I proceed as follows.

The Sovereign Certificates that are to be created and issued will bear the Type label of Sovereign. They will be sold and traded exclusively on the fully electronic Exchange created and owned by my company.

Once a week, for a period of 40 weeks, I will create and issue Certificates in the amount of $25.0 billion dollars. For the entirety of the 40 weeks, they will be issued as Fixed Class, then be transformed into Active Class Certificates at the end of the 40 weeks. Each weekly issuance of $25.0 billion dollars will be parceled into 25 million Certificates, with an initial offering price of $1000.00 each. The Trading Rate will be limited to one trade in a 12 month period. The Appreciation Rate is set at 5%.

Over the next 40 weeks, all new offerings are sold. At the end of the trading day, all capital raised is transfered to the government. The government has been given $1.0 trillion dollars in just ten months to be used to eliminate part of the National Debt. The Federal government has incurred no debt.

The investors who purchased the Certificates have exercised their right to trade, and have made 5% on their investment.

At the end of the 40 weeks, and after the mandatory 30 day waiting period, the Certificates are aggregated, their sum divided by the number of Certificates outstanding, and a uniform price of $1050.00 per Certificate is established for the transformation to the Active Class of Certificates. Once transformed to the Active Class, the price of each Certificate will be $1050.00.

Example: The XYZ Financial Corporation is a publicly traded large capitalization company which specializes in commercial and investment banking. Because of a series of bad investments and other financial missteps, the company had to be bailed out by the Federal government, and now has the government as its majority shareholder. In order to make the company more profitable and increase lending, the government would like to remove $60.0 billion US dollars in nonperforming asset backed securities from its books. I approach the government with an offer of assistance utilizing The Sovereign Certificates Issuance Plan. The government accepts my offer of assistance, and directs me to provide it with $60.0 billion dollars over a period of 24 months. I proceed as follows.

The Sovereign Certificates that are to be created and issued will bear the Type label of Sovereign-Private. They will be sold and traded exclusively on the fully electronic Exchange created and owned by my company.

Once a week, I will create and issue Certificates in the amount of $3.0 billion dollars. This will be done over a period of 20 weeks. For the entirety of the 20 weeks, they will be issued as Fixed Class, then be transformed into Active Class Certificates at the end of the 20 weeks. Each weekly issuance will be parceled into 150 million Certificates, with an initial offering price of $20.00 each. The Trading Rate will be limited to one trade in a 12 month period. The Appreciation Rate is set at 10%.

Over the next 20 weeks, all new offerings are sold. At the end of each trading day, all capital raised is transferred to the government. The government has been given $60.0 billion dollars in just over 4 months to provide to the XYZ Financial Corporation. This will allow the corporation to sell its nonperforming securities at a greatly discounted price and not suffer a capital loss on its books. In this process, the Federal government has incurred no debt, and no taxpayer money was given to the corporation.

The investors who purchased the Certificates have exercised their right to trade, and have made 10% on their investment. Those who purchased the securities now have a guarantee from the Federal government that if the corporation is dissolved through bankruptcy, is purchased by another company, or nationalized, the Certificates will automatically transform into the Certificates labeled Sovereign, thus preventing a huge capital loss.

At the end of the 20 weeks, and after the mandatory 30 day waiting period, the Certificates are aggregated, their sum divided by the number of Certificates outstanding, and a uniform price of $22.00 per Certificate is established for the transformation to the Active Class of Certificates. Once transformed to the Active Class, the price of each Certificate will be $22.00.

Example: The ABCD Corporation is a publicly traded mid-capitalization corporation that designs and builds jet engines for commercial and military aircraft. It has just received a patent for a new type of engine that will be more fuel efficient while still being able to provide the power necessary to fly an aircraft. The corporation estimates its startup costs for production will be $2.0 billion US dollars. It approaches the Federal government for financial assistance. The government agrees to give $1.0 billion. Instead of a grant, it directs me to issue Certificates to provide it with the money. I proceed as follows.

The Sovereign Certificates that are to be created and issued will bear the Type label of Private. They will be sold and traded exclusively on the fully electronic and computerized Exchange created and owned by my company.

The Certificates are parceled into 50 million Certificates, and sold at an initial offering price of $20.00 each. The Certificates are issued as Active Class.

The Certificates are fully sold in the course of one day. The money is transferred to the government, which then gives it to the corporation. The Federal government has incurred no debt, and in the process assisted a company whose work it hopes will contribute positively to the economy.

Investors who purchased the securities have an investment instrument guaranteed by the Federal government. If the corporation enters bankruptcy and is dissolved, or if the company is purchased by another corporation, or nationalized by the government, the Certificates will automatically transform into the Type of Certificate labeled Sovereign, preventing a huge capital loss.

If an intervention to transform one Class of Sovereign Certificates into another Class is necessary to control excess inflows or outflows of capital, a notification of at least 12 hours will be given prior to the transformation. If, in my analysis, I believe the situation to be an emergency, no prior notification of the intervention will be given. The intervention will be swift and immediate if necessary.

When a Sovereign Certificate is issued with the stipulation that it will automatically transform from one Class into another Class at some predetermined point in the future, there will be a mandatory waiting period of 30 days prior to the transformation. This will provide time for investors who can trade to do so, for valuation and pricing of the securities to be done, and legal matters concerning the transformation to be completed. If a situation arises that I define as an emergency, the 30 day waiting period will be negated, and the transformation will take place swiftly and immediately.

1. I, Galvin Flowers, Jr., a resident of 207 Old Liberty Pike in Franklin, Tenn. 37064, and citizen of the United States of America, do hereby declare that I believe I am the original, first and sole inventor and owner of the subject matter which is claimed and for which a patent is sought; a business method titled The Sovereign Certificates Issuance Plan, and the components that it is comprised of; the actual business method whose purpose and design will enable me to work in a public-private relationship with the Federal government to provide it with funds that it will not have to classify as debt and repay, and the rules created for it; the new investment security called a Sovereign Certificate that will work in conjunction with the actual business method, the rules created for the security and the components it is comprised of; the three Types called Sovereign, Sovereign-Private, and Private, and the rules created for them; the two Classes called Active and Fixed, including two components of the Fixed Class called the Trading Rate and the Appreciation Rate, and the rules created for all of them; the transformation process, and the rules created for it; the intervention process, and the rules created for it;
the selling and trading of the Certificates exclusively on a computerized Exchange; the issue of government guarantees for the Certificates; the rules pertaining to the ownership of the Certificates; the valuation and pricing of the securities, and the rules created for the process; and the mandatory waiting period, with the rules created for it.
